(19) United States
(12) Patent Application Publication
(10) Pub. No.: US 2009/0301661 A1
(43) Pub. Date: Dec. 10, 2009

(54) DEVICE FOR WELDING A FILM WEB

(76) Inventors: Roman Kammler, Worms (DE); Ralf Bardtke, Dautphetal (DE); Walter Baur, Grundau (DE)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 12/300,531

(22) PCT Filed: Mar. 28, 2007
(86) PCT No.: PCT/EP07/02733

§ 371 Date: Mar. 16, 2009

(30) Foreign Application Priority Data
May 12, 2006 (DE) 10-2006-022-192.3

(51) Int. Cl. B32B 37/02

(52) U.S. Cl. 156/538

(57) ABSTRACT

The invention relates to a device (1) comprising two welding jaws (2, 3) that can be displaced towards one another in order to weld a formed film web (4) or tubular film (5). In said device, each welding jaw (2, 3) is connected to a separate jaw support (7, 8), preferably by means of a jaw holder (6). A drive (9) comprising two linear motors (10, 11) is connected to the jaw supports (7, 8) by means of a mechanism in order to generate an opposing jaw displacement. To achieve a compact construction for the drive (9), the secondary parts (13, 15) of the linear motors (10, 11) are interconnected by means of a magnetic shielding (19) and thus form a unit (20).

The invention relates to the construction of packaging machines and in particular to a drive mechanism for welding jaws which can be displaced against one another on vertical bagging machines.

Vertical bagging machines and horizontal bagging machines are known per se. They serve for filling of a product into bags. For welding of the bag material, two welding jaws are used which are displaceable against one another and which clamp a film material in between, and weld it in this manner.

From DE 195 35 510 A1, a device is known comprising two welding jaws displaceable against one another for welding a film web formed into a tubular film. For this, each welding jaw is connected with a separate jaw support by means of a jaw holder. A drive is connected with the jaw supports by means of a mechanism to carry out an opposing jaw displacement using the drive which comprises two linear motors. The linear motors each comprise one primary part and one secondary part.

The known device has the disadvantage that it is relatively bulky since the parts of the two linear motors (electro-magnetic linear drives) are constructed separately.

The underlying object is to eliminate this disadvantage.

The object is solved according to the characterizing portion of the claim 1. Accordingly, the two secondary parts are interconnected by means of a magnetic shielding, and thus form a unit.

The proposed innovation has the advantage that two secondary parts are structurally combined, whereby a compact construction is achieved. To prevent a disturbance of their function, a magnetic shielding is provided between the secondary parts. The same can be made of an electrically conductive material, in particular metal. For this, the metal must not be magnetizable. On the one hand, such a connection can be intended in a manner that the magnets of the separate secondary parts are mounted on opposite sides of the shielding. On the other hand, a separate holder can be provided for the secondary parts, and the shielding functioning for both secondary parts separates only these parts.

Advantageous embodiments of the proposed device are described in the claims 2 to 9.

If the secondary parts are aligned parallel to one another (claim 2), then different displacement sequences in one direction to displace the welding jaws can be generated by means of a relative displacement of the linear motors. If, however, according to claim 3, the secondary parts are aligned perpendicular to one another, thus forming a cross formation, then different displacements, which are perpendicular to one another or are combined with each other, respectively, of a jaw clamp can be generated, in particular, on the one hand, to lift and to lower the jaw clamp, and, on the other hand, to open and close the jaws at the same time.

Another advantage of the compact unit as drive element for the welding jaws is its stability against distortion when the secondary parts are attached on different sides of the shielding (claim 6) serving as holder. Thus, the secondary parts attached on opposite sides of the shielding equalize each other with respect to their tendency to bend the shielding due to their own heating. The unit remains without noteworthy distortion even at high power and corresponding heating of the secondary parts. Suitable as magnetic shielding are non-magnetizable light metals, such as aluminum and magnesium (claim 4), whereby, in addition, the displaceable unit becomes relatively light. Also, the shielding can be the holder whereby one component can be saved.

To avoid a bending of the holder, in particular in case of a one-sided attachment of the two secondary parts on a holder, and hence a rough running of the device, it is proposed to provide a sequence of separate secondary sub-segments as a secondary part, wherein each secondary sub-segment is connected with a holder of the secondary part by a fastening means (claim 5). Manufacturing inaccuracies of only few micrometers, which exist in the practice, whereby the secondary sub-segments still abut closely against one another, or exactly specified gaps between the secondary sub-segments (claim 7) result then in that with a conventional screw connection or a partial adhesive bonding of the secondary sub-segments, a heating-related, relatively strong linear expansion of the secondary sub-segments does not result in a bending of the holder of the secondary part. Suitable as fastening means are screws, rivets, and adhesives (claim 8).

The device can be part of a vertical tubular bagging machine or a horizontal bagging machine (claim 9).

In the following, the invention is described by means of Figures illustrating exemplary embodiments. In the figures:

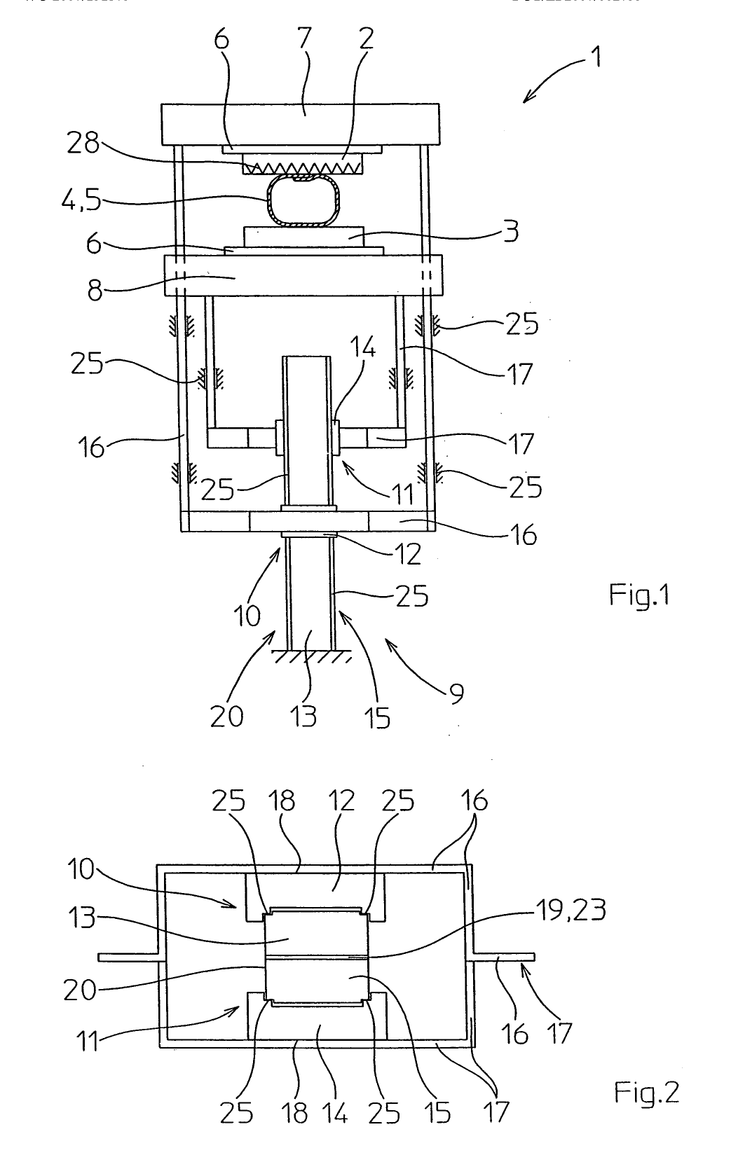

FIG. 1 shows a top view of a device for welding a tubular film of a bagging machine comprising two linear motors for separate driving of one welding jaw, respectively, with open welding jaws, wherein the secondary parts of the linear motors are included in a unit;

FIG. 2 shows a side view of the unit of FIG. 1, wherein always one primary part, respectively, attached on a connection to a welding jaw is displaceable relative to a secondary part, and is provided between the secondary parts of a magnetic shielding;

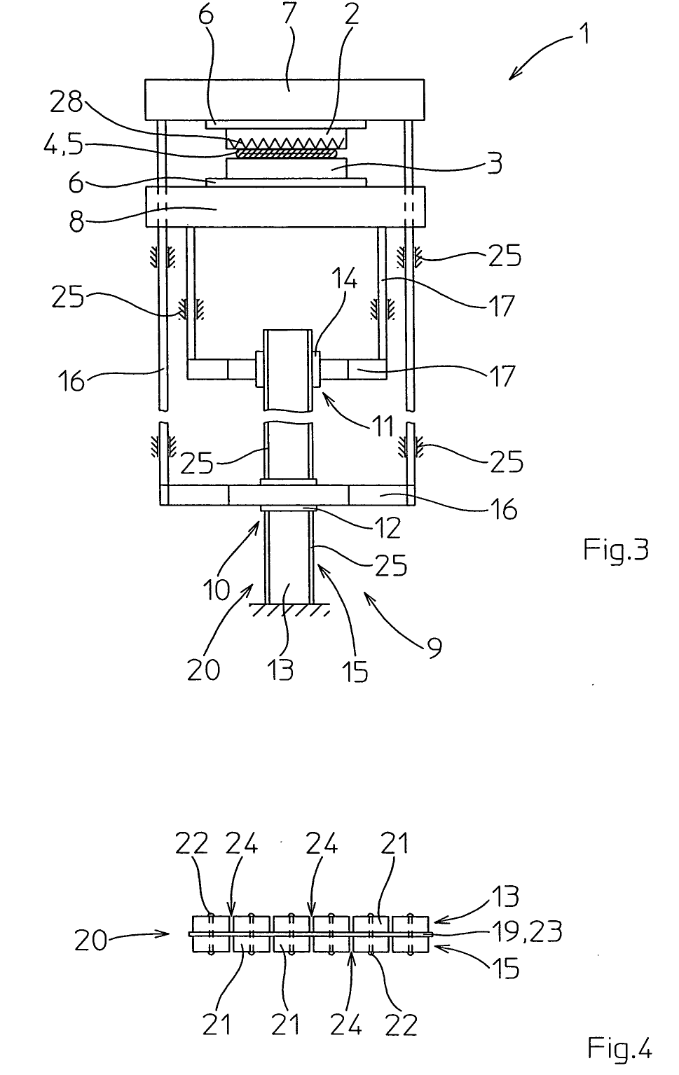

FIG. 3 shows a top view of the device of FIG. 1, but with closed welding jaws;

FIG. 4 shows a side view of a unit comprising two secondary parts, wherein each of the secondary parts consists of a sequence of separate secondary sub-segments;

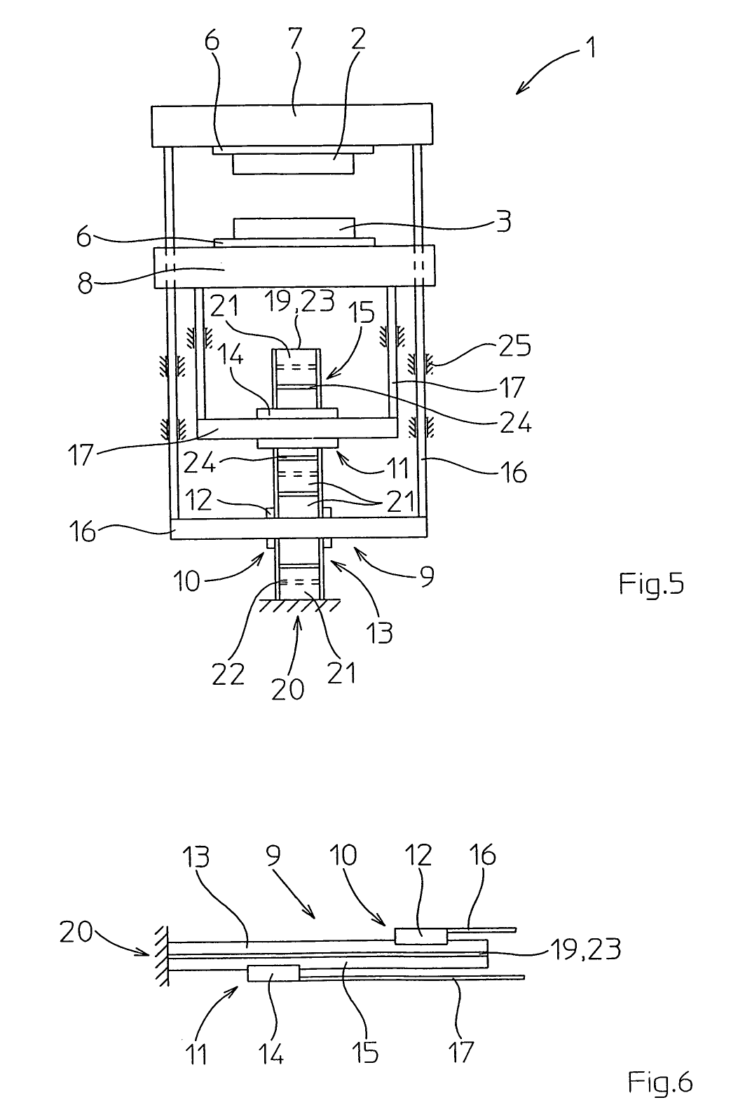

FIG. 5 shows a top view of a device analog to FIG. 1, but with a secondary part analog to FIG. 4;

FIG. 6 shows, in an exemplary embodiment, a side view of a drive for a jaw mechanism according to the FIGS. 1 or 5, which uses two primary parts displaceable on opposite sides of a stationary double secondary part to displace one welding jaw (not shown), respectively, by means of a primary partial displacement;

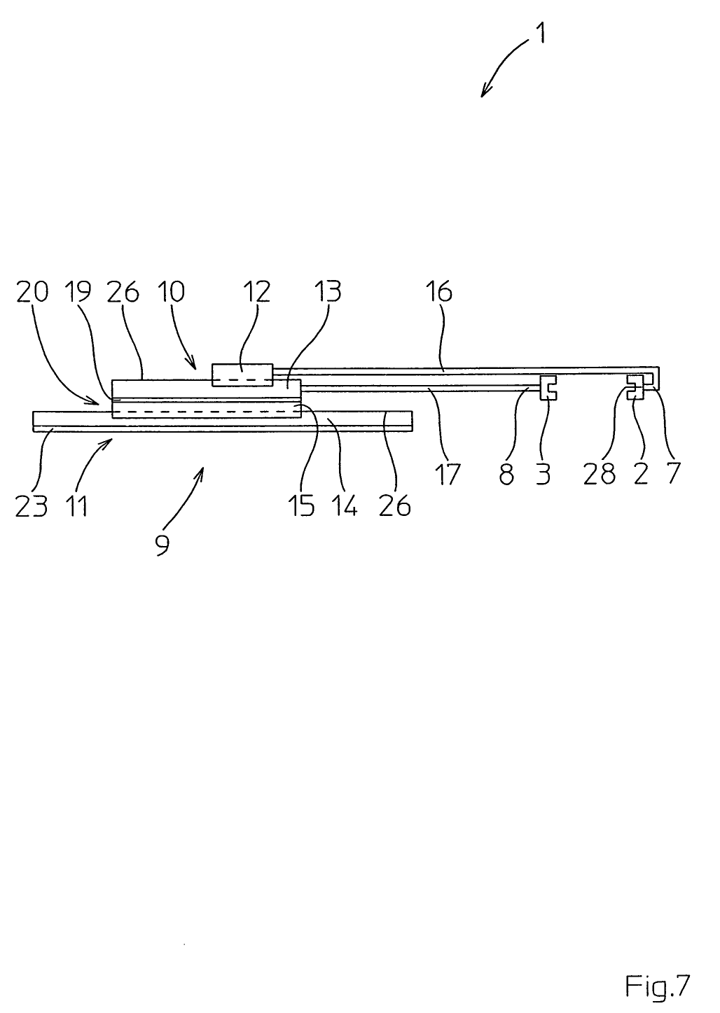

FIG. 7 shows, in a further exemplary embodiment, a side view of a drive which comprises two linear motors mounted on top of each other and a unit containing two secondary parts to displace a jaw mechanism;

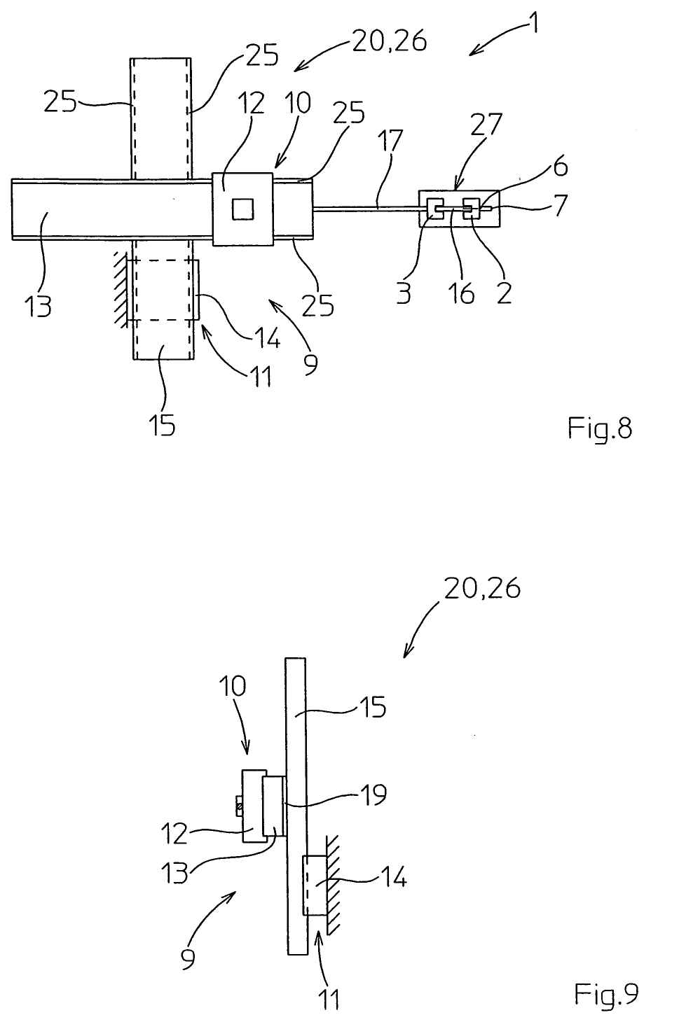

FIG. 8 shows a side view of a device for displacing a jaw clamp in a vertical direction as well as for opening and closing the welding jaws in a horizontal direction, wherein the drive comprises two linear motors, the secondary parts of which are aligned perpendicular to one another and are interconnected within a unit by means of a magnetic shielding, and

FIG. 9 shows the drive of FIG. 8 in a side view shifted 90 degrees to the view of FIG. 8.

In a device 1 comprising two welding jaws 2, 3 against one another for welding a film web 4 formed into a tubular film 5, each welding jaw 2, 3 is connected with a separate jaw support 7, 8 by means of a jaw holder 6 (FIGS. 1, 2 and 3). A drive 9 is connected with the jaw supports 7, 8 by means of a mechanism to carry out an opposing jaw displacement using the linear motors 10, 11. As a drive 9, two linear motors 10, 11 are provided aligned next to one another and parallel to one another, each of them comprising one primary part 12, 14, respectively, and each of them comprising one secondary part 13, 15, respectively. Always one displaceable part, respectively, of the linear motor 10, 11 is connected with a jaw support 7, 8 by means of a joint 27 and by means of a connection 16, 17. The connections 16, 17 are guided in horizontal direction by means of guideways 25. The welding jaws 2, 3 are part of a transversal seal station of a vertical bagging machine. A deflectable cutting knife 28 in a welding jaw 2 serves for cutting off a finished tubular bag from the tubular film 5.

For the linear motors 10, 11, the secondary part 13, 15 is always stationary, and the primary part 12, 14 is constructed as displaceable part, respectively. With each housing of a secondary part 13, 15, two guideways 25 are connected, along which the slides (not shown) of the displaceable primary parts 12, 14 glide. The primary parts 12, 14 attached to the connections 16, 17 have a common cooling and power supply (not shown).

The linear motors 10, 11 can displace the welding jaws 2, 3 separately and as desired by shifting of their primary parts 12, 14. They can be operated depending on any chosen diameter of a tubular film 5 with respect to a maximum distance of the welding jaws 2, 3 to one another to always carry out a minimal jaw displacement sufficient for a welding process. Moreover, the impact plane of the sealing surfaces of the welding jaws 2, 3 can be shifted in horizontal direction, and the welding jaws 2, 3 can be displaced differently. Thus it is possible to occasionally close the welding jaws not completely, and thereby shift them slightly away from the impact plane in order to achieve, with deflected cutting knife 28 and horizontally shifted and thereby tensioned and welded tubular film 5, just a perforation of the flattened tubular film 5 by means of the tips of the cutting knife 28 with unchanged cutting knife deflection.

The two secondary parts 13, 15 which are aligned parallel to one another are interconnected by means of a magnetic shielding 19, thus forming a stationary unit 20.

In the exemplary embodiments of the FIGS. 4 and 5, the secondary parts 13, 15 of the unit 20 are each structured from a sequence of secondary sub-segments 21 to avoid a distortion of the shielding 19 serving as holder 23. For this, each secondary sub-segment 21 is connected separately with the holder 23 by a fastening means 22, e.g. in the form of screws (FIG. 4), or in the form of a narrow adhesive path (FIG. 5). For further avoiding of a distortion of the unit 20 due to its heating or the heating of its magnets, respectively, during the operation of the primary parts 12, 14, always between two secondary sub-segments 21, a gap 24 is provided which allows that at first, the secondary sub-segments 21 expand stronger at start of operation than the holder 23 of the unit 20. The unit 20 formed distortion-free in this manner results in a smooth and long-lasting operation of the device 1 and allows identical welding results at any time.

In the exemplary embodiment of FIG. 6, using the analog jaw mechanism, the secondary parts 13, 15 are each constructed as one piece, and are interconnected by means of a magnetic shielding 19 to thereby forming a stationary unit 20. The shielding 19 is provided as holder 23. It is made of aluminum. The outer covers of the secondary parts 13, 15 are made of steel. By attaching the secondary parts 13, 15 on the opposite sides of the holder 23, the distortion forces due to heating are equalized so that the holder 23 remains straight. The magnetic shielding 19 serves for a reliable operation of the two primary parts 12, 14 along the unit 20.

In the exemplary embodiment of FIG. 7, the linear motors 10, 11 are mounted on top of each other, whereby a secondary part 15 of the one linear motor 11 carries the other linear motor 10. This drive 9 is able, like the drive 9 of FIG. 6, to displace the welding jaws 2, 3 against one another without a gear, just by means of the connections 16, 17. Concerning secondary sub-segments 21, unit 20, shielding 19, and materials, the same applies as previously described. The secondary parts 13, 15 of the linear motors 10, 11 form a compact displaceable unit 20. The primary part 14 of the one linear motor 11 is mounted stationary. The unit 20 is guided and displaced along this primary part 14 by means of rails 26 which are separate or are attached on the primary part housing. The primary part 12 of the other linear motor 10 is guided and displaced along the unit 20 by means of rails 26 which are mounted on the unit 20, or are mounted separately and parallel thereto. The unit 20 is connected with the one welding jaw 3 by means of a rigid connection 17. The primary part 12 of the other linear motor 10 is connected with the other welding jaw 3 by means of a rigid connection 16. In that by a deflection of the lower linear motor 11, both welding jaws 2, 3 are displaced similarly, the upper linear motor 10 has to be operated opposing to the lower linear motor 11, simply to not displace the welding jaw 2 allocated to it. Only by a deflection of the primary part 12 beyond this, relative to the unit 20, the welding jaw 2 is caused to be displaced relative to the welding jaw 3. A control and regulation (not shown) is configured to cause a jaw displacement which is adequate and optimized for each packaging operation, respectively.

In the exemplary embodiment of the FIGS. 8 and 9, the secondary parts 13, 15 are aligned perpendicular to one another, thus forming a cross formation 26. The secondary parts 13, 15 of the unit 20 are separated from one another only in their crossing region by means of a magnetic shielding 19. By operating the stationary primary part 14 relative to the secondary part 15 of the one linear motor 11, the cross formation 26 together with the jaw clamp 27 is lifted and lowered. By operating of the primary part 12 of the other horizontally displaceable linear motor 10, this primary part 12 is shifted relative to the secondary part 13 connected rigid with the secondary part 15. This pure horizontal displacement opens and closes the jaw clamp 27 by means of gear (not shown) known per se, e.g., a toggle lever. Thus a displacement of the jaw clamp 27 can be configured for a continuously transferred, i.e. without a stop, tubular film 5.

1-9. (canceled)

10. A device comprising:
a first welding jaw;
a second welding jaw wherein the first and second welding jaw may be displaced against one another for welding a formed film web or a tubular film;
a first jaw support coupled to the first welding jaw;
a second jaw support coupled to the second welding jaw; and
a drive coupled to the first and second jaw support to generate an opposing welding jaw displacement, the drive comprising two linear motors wherein each linear motor comprises one primary part and one secondary part wherein the secondary parts of the two linear motors are interconneted by a magnetic shielding to form a unit.

11. The device according to claim 10, wherein the secondary parts of the two linear motors are aligned parallel to one another.

12. The device according to claim 10, wherein the secondary parts of the two linear motors are aligned perpendicular to one another to form a cross formation.

13. The device according to claim 10 wherein the magnetic shielding is formed by a non-magnetizable light metal.

14. The device according to claim 13 wherein the non-magnetizable light metal comprises aluminum or magnesium.

15. The device according to claim 10 wherein at least one of the secondary parts of the two linear motors comprises a sequence of separate secondary sub-segments coupled to a holder of the secondary part.

16. The device according to claim 15, wherein the magnetic shielding is provided as the holder.

17. The device according to claim 15 wherein the secondary sub-segments abut closely against one another.

18. The device according to claim 15 wherein a gap is provided between two adjacent secondary sub-segments.

19. The device according to claim 15, further comprising a fastener coupling the secondary sub-segments to the holder.

20. The device according to claim 19 wherein the fastener is selected from a group comprising an adhesive, a screw connection, and a rivet connection.

21. The device according to claim 10 wherein the device is part of a vertical tubular bagging machine or of a horizontal bagging machine.
